(19) United States
(12) Patent Application Publication
(10) Pub. No.: US 2017/0243274 A1
(43) Pub. Date: Aug. 24, 2017

(54) METHOD FOR TARGETED ELECTRONIC DISTRIBUTION OF PROMOTIONS

(71) Applicant: Ransford Quarrie, Hamilton, NJ (US)

(72) Inventor: Ransford Quarrie, Hamilton, NJ (US)

(21) Appl. No.: 15/048,866

(22) Filed: Feb. 19, 2016

(51) Int. Cl. G06Q 30/06; G06Q 30/02

(52) U.S. Cl. CPC G06Q 30/0625; G06Q 30/0617; G06Q 30/0639; G06Q 30/0222

(57) ABSTRACT

A computer implemented method with an intelligent event notification related to specific item is provided. The computer implemented method involves a means for providing a consumer with any and all notification related a product or a service, however a user of the computer implemented method is provided with a mean wherein the user may select items and services of choice in a specific geographic location. Furthermore, the computer implemented method provides a user with a means to create an online profile with a option to find various items of interest or view what other users are interested in and receive updates about items. Lastly, the user may add or remove items or services a user wants to be alerted about.

### FIELD OF INVENTION

The present invention relates generally to discounting and promotion of goods and services to consumers, and, more particularly, to the targeted electronic distribution of promotions, such as discounts, rebates and special prices for specific goods and services to a specific consumer.

### BACKGROUND OF INVENTION

Currently, promotion efforts require a consumer to take a specific action to enable his or her discounts on a product or service. For instance, the consumer is required to bring in a paper coupon for redemption. In a modern supermarket, the consumer must make a selection at a kiosk to enable his discount at the checkout counter. Ideally, having a database of all consumers would allow the precise targeting of advertisements, discounts, or special prices to individual consumers. The effectiveness of consumer database targeting would be maximized so that promotion money is spent where it is effective and not spent when it is ineffective. To that end, producers and retailers have used emerging technologies to identify consumers and their purchasing interests. Hence, much of the modern promotion efforts have been directed as much toward gathering consumer information, as well as encouraging the purchase of specific items. Surveys using modern polling techniques have helped create such consumer databases, and computers have been used to correlate buying patterns of customers through store loyalty cards, for example. However, such consumer identification remains elusive and expensive, and the targeting of consumers remains difficult and costly.

A number of different types of applications and devices are available in the prior art for example; U.S. Pat No. 8,175,928 assigned to Pure Verticals Inc., shows an e-commerce system comprising a master console software application executing on a first network-connected server and accessible to a plurality of external systems used by merchants, a shopping cart software application executing on a second network-connected server and coupled to the first server, and interface software executing on the second server for interacting with content associated with a first user is disclosed, wherein a merchant interacts with the master console software application to load information about a product available for promotion and sale by the first user, the master console software application makes that information available to the shopping cart software application, and the interface software provides information and code related to the specific product to the content, the code compatible with the content, and upon the code being activated in the content by a second user, the second user is connected to the shopping cart software application, and is thereby enabled to buy the product. U.S. Pat. No. 8,000,998 B2 assigned to Ds-Iq, Inc., demonstrates a method of extending promotional discounts and special prices on items for sale to identified consumers. After the identification of a consumer by a unique identifier; a selected item is promoted with a discount or special price to the identified consumer. The discount or special price is granted upon a purchase of the item by the identified consumer prior to the withdrawal or termination of the promotion to the identified consumer. The withdrawal or termination of the promotion is held in abeyance upon an acknowledgment of the promotion by the identified consumer. In other words, the identified consumer must take specific action to prevent a promotional discount from being withdrawn. This inverted promotion provides for greater incentives for the consumer to provide information about his or her purchasing habits.

U.S. Patent Application No. 20140344062 issued to Carl LaMont depicts a computer-readable media for providing and receiving relevant data from one or more entities. Data is received by a wireless user device directly from a wireless transmitter. The data may be provided to a stationary or moving user. A consumer in a vehicle, for instance, may have a smartphone, mobile phone, tablet PC, navigation system, or other similar mobile device, and can use such device to interact with a geographically proximate advertising module having a wireless transmitter. U.S. Patent Application No. 20130138507 issued to Kumar shows a method for facilitating a predictive advertising campaign and in one embodiment an advertising analytics server is programmed with a predictive advertising engine and an advertisement personalization engine. U.S. Patent Application No. 20060064333 issued to Razza discloses a product availability tracking and notification system and method that automatically alerts consumers of product availability, such as air travel fares after an initial search is performed which meets the criteria of the user. To obtain current price information, internally generated queries and user generated queries that match trips being tracked with corresponding search criteria are provided.

However, none of the above inventions and patents, taken either singly or in combination, is seen to disclose a method or system with a means for providing a consumer with any and all notifications related a product or a service of interest identified by a consumer automatically on an electronic device for a specfice period of time and geographical location.

### BRIEF SUMMARY OF THE INVENTION

The present invention is to directed to a computer implemented method providing a consumer with any and all notifications related to a product or a service of interest identified by the consumer automatically on an electronic device for a specific period of time and geographical location.

Furthermore, the computer implemented method provides a user with a means to create an online profile with a option to find various items of interest or view what other users are interested in and receive updates about items. Lastly, the user may add or remove items or services a user wants to be alerted about. Moreover, a user will continually receive notifications or alerts until a user removes the item of interest from their search profile. When user receives a serch notification or alert related to their specific profiled product, they could buy it instantly if online and or go to a store near them.

The computer implemented method also includes the following steps: identifying a consumer by a unique identifier; promoting a selected item with a discount or special price to the identified consumer; withdrawing the discount to the identified consumer; granting the discount or special price upon purchase of the item by the identified consumer prior to the withdrawing step; and holding the withdrawing step in abeyance upon an acknowledgment of the promoting step by the identified consumer.

In another preferred embodiment, the computer implemented method may include the following additional steps: selecting a type of event notification; determining the type of event based, in part, on information elements associated with the event; determining at least one optimal alert system to receive an event notification corresponding to the type of event notification selected. The determination is based in part on information elements associated with the event.

The computer implemented method further includes associating an alert trigger with the event notification and transmitting the event notification to the at least one optimal alert system upon activation of the alert trigger. The event notification type includes a supplemental information notification specifying activities to be performed in advance of, or in preparation for, the event.

### DETAIL DESCRIPTION OF THE INVENTION

In today's world advertising is everything, but consumers hardly have the time to watch commercials or search for sales. Someone could search the internet for hours and not find a sale, but the second they stop a sale could have come and went without them knowing. It is also impossible for one person to search everywhere for a sale. Therefore, the present invention is directed to a computer implemented method for providing a consumer with any and all notifications related to a product or a service of interest identified by the consumer automatically on an electronic device for a specific period of time and geographical location.

In one preferred embodiment, the computer implemented method is a search engine that searches for sales on things a user would want while they're not physically searching. By way of example, but not of limitation, if a user typed in a product ex. (Nike golf shirt, cereal, TV, Michael Kors watch) the methods search engine would search the web and stores near to the users location, for example in a mile radius, for a sales offer on that item. More specifically, the computer implemented method is constantly searching for sales on that product and when it's found, the user will get a notification with the sale instantly. These notifications can come at any time, meaning the user could get the notification a week later, months later, the next day or a few minutes later. Therefore, when a sale emerges on that item, the user will be notified. If a user typed in a business ex. (Best Buy, Walmart, Bath & Body Works, and Sephora) they would then start to receive sales on items from that specific business. Also, the user would be able to set the amount of sales notifications received. The final feature of the search engine is discontinued items. The system would track the products and businesses the user uses and alert the user if one of those items would be discontinued. These alerts would come prior to the product being discontinued, thus giving the user time to go to the store to purchase the product before it's discontinued. The computer implemented method of the present invention is more than just a search engine in that a profile feature is included. More particularly, the computer implemented method provides a user with a means to create an online profile with a option to find various items of interest or view what other users are interested in and receive updates about items. Lastly, the user may add or remove items or services a user wants to be alerted about. Moreover, a user will continually receive notifications or alerts until a user removes the item of interest from their search profile. When user receives a serch notification or alert related to their specific profiled product, they could buy it instantly if online and or go to a store near them. For example, the user could post things the user has purchased, ex. (Nike golf shirt, Michael Kors watch, Express jeans) wherein after posting, a user can write reviews ex. (“Love my watch!!”, “Fits kind of small XL fits like L”). As described above, the user would also be able to look at other pages or featured products to see what's hot or what other people are buying.

In another preferred embodiment the computer implemented method provides a means for a user to know what everyone else is buying. For example, if a user wants to know what face cream Beyoncé was using. The user could know if he/she went to her profile and that was something she posted. Maybe someone wants to know what shoe's Kanye just bought or what shampoo a certain hair salon promoted. Even knowing what other users purchased or see reviews on how a shirt fits, its all made simple in the profile. For the user its shopping made easy, and in the best way people like it in sales. This could change the way shopping is done for the seasons, knowing winter things go on sale in the summer and summer things in the winter. It can change the way holiday or birthday shopping is done, knowing the holidays or birthday is coming user can type in things to be gifted early and wait for the sale.

The computer implemented method of the present invention can be implemented on any communication device that has hardware components that can perform wireless and wired communication, such as (but not limited to)—desktop computer, multi-purpose pocket computers, cellular telephones, personal multimedia devices, etc. The various devices on which the applications that implement the present invention run may use one or more processors with different instruction-sets, architectures, clock-speeds, etc. and memory that may include high speed random access memory and may include non-volatile memory, such as one or more magnetic disk storage devices, flash memory devices, and other kinds of solid state memory devices.

It is to be understood that the above description is intended to be illustrative, and not restrictive. For example, the above discussed embodiments may be used in combination with each other. Many other embodiments will be apparent to those of skill in the art upon reviewing the above description.

What is claimed is:

1. A computer implemented method providing a consumer with any and all notifications related to a product or a service of interest identified by the consumer automatically on an electronic device for a specific period of time and geographical location, comprising the steps of:
creating an online user profile with a option to find various items of interest or view what other users are interested in;
sending updates notifications and alerts to the user about said items; wherein the user will continually receive notifications or alerts until a user removes the item of interest from their search profile; wherein when the user receives a serch notification or alert related to their specific profiled product, they could buy it instantly if online and or go to a store near them.

2. The computer implemented method according to claim 1, including the following steps:
identifying a consumer by a unique identifier;
promoting a selected item with a discount or special price to said identified consumer;
withdrawing said discount to said identified consumer;
granting said discount or special price upon purchase of said item by said identified consumer prior to said withdrawing step; and
holding said withdrawing step in abeyance upon an acknowledgment of said promoting step by said identified consumer.

3. The computer implemented method according to claim 1, including the following steps:
selecting a type of event notification;
determining said type of event based, in part, on information elements associated with said event;
determining at least one optimal alert system to receive an event notification corresponding to a type of event notification selected wherein said determination is based in part on information elements associated with said event.

4. The computer implemented method according to claim 1, including the following steps:
associating an alert trigger with an event notification;
transmitting said event notification to at least one optimal alert system upon activation of said alert trigger wherein said event notification type includes a supplemental information notification specifying activities to be performed in advance of, or in preparation for, said event.
